(19) United States
(12) Patent Application Publication
(10) Pub. No.: US 2026/0245756 A1
(43) Pub. Date: Aug. 20, 2026

(54) Nuclear Power Plant, Control Device for Nuclear Power Plant, and Control Method for Nuclear Power Plant

(71) Applicant: Hitachi GE Vernova Nuclear Energy, Ltd., Hitachi-Shi, Ibaraki (JP)

(72) Inventors: Yukinori KATAGIRI, Tokyo (JP); Yohei MURAKAMI, Tokyo (JP)

(21) Appl. No.: 19/162,580

(22) PCT Filed: Mar. 28, 2024
(86) PCT No.: PCT/JP2024/012679

§ 371 Date: Sep. 5, 2025

(30) Foreign Application Priority Data
May 16, 2023 (JP) 2023-080691

(51) Int. Cl. G21D 3/12; G21D 9/00

(52) U.S. Cl. CPC G21D 3/12; G21D 9/00

(57) ABSTRACT

Provided are a nuclear power plant, a control device for the nuclear power plant, and a control method for the nuclear power plant that can be utilized for power supply-demand balance adjustment when a large amount of renewable energy is connected to a system. This nuclear power plant is configured to supply steam generated in a nuclear reactor to a high-pressure turbine through a main steam control valve and supply a portion of the steam generated in the nuclear reactor to a moisture separation heater through an adjustment valve to heat exhaust steam from the high-pressure turbine. The nuclear power plant is characterized in that the reactor pressure is controlled by adjusting the amount of steam to the moisture separation heater.

### TECHNICAL FIELD

The present invention relates to a nuclear power plant, a control device for a nuclear power plant and a control method for a nuclear power plant.

### BACKGROUND ART

In a power generator output control of a boiling water type nuclear power plant, a nuclear reactor output is first adjusted in accordance with a deviation between a target power generator output value and a current actual power generation output value, and then an actual power generation output is adjusted to the target power generator output value by supplying steam generated in accordance with the nuclear reactor output to a turbine. In a boiling water type nuclear reactor, a sudden change in pressure in the nuclear reactor causes a change in a state of steam bubbles (hereinafter referred to as voids) in a coolant, which eventually leads to a sudden change in the nuclear reactor output. Therefore, to prevent a sudden change in the pressure in the nuclear reactor, measures are taken such as setting a limit on an opening and closing speed for a flow rate adjustment valve provided at an inlet to a steam turbine (hereinafter referred to as a main steam control valve).

Patent Literature 1 illustrates an example of an output control device that adjusts a power generator output while stably operating the nuclear reactor. According to Patent Literature 1, an extraction steam valve, which is provided between the main steam control valve and the turbine to supply a portion of the steam to other equipment, is controlled based on the deviation between the target power generator output value and the actual power generation output value. A degree of contribution of opening and closing of the extraction steam valve to a change in the power generator output is determined to control nuclear reactor control rods based on a deviation between the result of subtracting the degree of contribution from a power generator output signal (corrected power generator output) and the target power generator output value.

### CITATION LIST

### Patent Literature

Patent Literature 1: Japanese Unexamined Patent Application Publication No. 2017-194312

### SUMMARY OF INVENTION

### Technical Problem

According to Patent Literature 1, the nuclear reactor output and a volume of steam at the extraction steam valve are controlled so that the power generator output is equal to a target power generator output. The starting point of the control is the nuclear reactor output, and the deviation between the change in the volume of steam in accordance with a change in the nuclear reactor output and the change in the volume of steam in accordance with the target power generator output is compensated by controlling the volume of steam at the extraction steam valve. In addition, a limit is set on an opening degree of the control valve of the extraction steam valve to prevent a sudden change in a nuclear reactor pressure.

Thus, according to Patent Literature 1, the pressure of the nuclear reactor increases or decreases depending on how the volume of steam at the extraction steam valve is controlled. As discussed above, a sudden change in the pressure of the nuclear reactor causes a sudden change in the nuclear reactor output, making it difficult to achieve expected performances in terms of both stable control of the nuclear reactor pressure and responsiveness of the power generator output.

The present invention was made in view of the matters described above, and its purpose is to provide a nuclear power plant, a control device for a nuclear power plant and a control method for a nuclear power plant that can be utilized for power supply-demand balance adjustment when a large amount of renewable energy is connected to a system by enabling a flexible change in the power generator output while stably controlling the nuclear reactor pressure.

### Solution to Problem

Based on the description above, the present invention provides a “nuclear power plant in which steam generated in a nuclear reactor is supplied to a high-pressure turbine through a main steam control valve, and a portion of the steam generated in the nuclear reactor is supplied to a moisture separation heater through an adjustment valve to heat exhaust steam from the high-pressure turbine, and a nuclear reactor pressure is controlled by adjusting the volume of steam to the moisture separation heater.”

The present invention also provides a “control device for a nuclear power plant in which steam generated in a nuclear reactor is supplied to a high-pressure turbine through a main steam control valve, and a portion of the steam generated in the nuclear reactor is supplied to a moisture separation heater through an adjustment valve to heat exhaust steam from the high-pressure turbine, the control device including: an integrated plant control section that determines a turbine power generator output command and a nuclear reactor thermal output command from a power generation output command provided; a main steam control valve control section that determines an opening degree command for the main steam control valve in response to the turbine power generator output command; a nuclear reactor control section that determines a nuclear reactor operation command and a nuclear reactor pressure setting value in response to the nuclear reactor thermal output command; and a pressure control section that controls an opening degree of the adjustment valve in accordance with a difference between the nuclear reactor pressure setting value and the nuclear reactor pressure measurement value.”

The present invention also provides a “control method for a nuclear power plant in which steam generated in a nuclear reactor is supplied to a high-pressure turbine through a main steam control valve, and a portion of the steam generated in the nuclear reactor is supplied to a moisture separation heater through an adjustment valve to heat exhaust steam from the high-pressure turbine, the control method including: determining a turbine power generator output command and a nuclear reactor thermal output command from a power generation output command provided; determining an opening degree command for the main steam control valve in response to the turbine power generator output command; determining a nuclear reactor operation command and a nuclear reactor pressure setting value in response to the nuclear reactor thermal output command; and controlling an opening degree of the adjustment valve in accordance with a difference between the nuclear reactor pressure setting value and the nuclear reactor pressure measurement value.”

### Advantageous Effects of Invention

The present invention can provide a control system for a nuclear power plant and a control method for a nuclear power plant that can be utilized for power supply-demand balance adjustment when a large amount of renewable energy is connected to a system.

### BRIEF DESCRIPTION OF DRAWINGS

FIG. 1 is a schematic configuration diagram related to a nuclear power plant and a control system according to an embodiment of the present invention.

FIG. 2 is a diagram illustrating an example of a schematic configuration of an integrated plant control means 101.

FIG. 3 is a diagram illustrating an example of a schematic configuration of a main steam control valve control section 102.

FIG. 4 is a diagram illustrating an example of a schematic configuration of a nuclear reactor control means 103.

FIG. 5 is a diagram illustrating an example of a schematic configuration of a pressure control section 104.

FIG. 6 is a graph illustrating operation characteristics of the nuclear power plant when a power generation output is controlled.

### DESCRIPTION OF EMBODIMENTS

An embodiment of the present invention is described with reference to the drawings.

### Embodiment

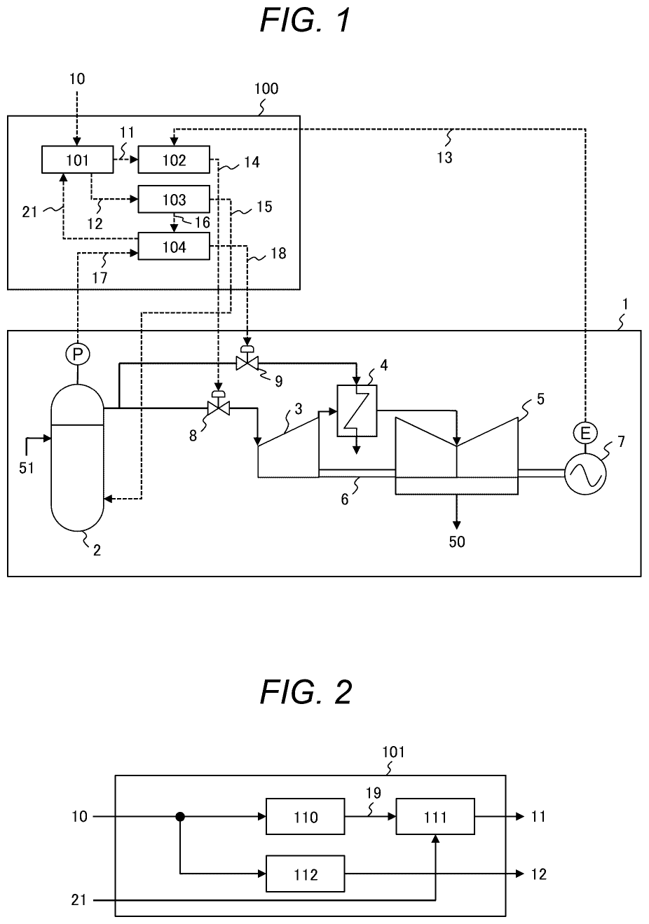

The schematic configuration of a nuclear power plant and a plant control device according to the present invention is described with reference to FIG. 1. The nuclear power plant 1 shown in FIG. 1 is controlled by the plant control device 100.

The nuclear power plant 1 shown in FIG. 1 includes a nuclear reactor 2, steam turbines (a high-pressure turbine 3 and a low-pressure turbine 5) and a power generator 7 as its main components, in which steam generated in the nuclear reactor 2 is supplied to the high-pressure turbine 3 through a main steam control valve 8 to rotationally drive it, and a portion of the steam is supplied to a moisture separation heater 4 through an adjustment valve 9 to reheat the steam exhausted from the high-pressure turbine 3 and then supplied to the low-pressure turbine for rotationally driving it. The steam turbines (the high-pressure turbine 3 and the low-pressure turbine 5) and the power generator 7 are coupled via a drive shaft 6 to rotate the power generator for generating electricity. According to this configuration, even when the nuclear reactor output is constant, the volume of steam flowing through the main steam control valve 8 and the adjustment valve 9 can be controlled to change, enabling the plant to be operated with a power generator output capable of being changed. Alternatively, even when the nuclear reactor output is changed, it can be operated at a constant power generation output.

First, the nuclear reactor 2, which is the main component in the nuclear power plant 1 shown in FIG. 1, is described. The nuclear reactor 2 in the figure represents a boiling water type light water reactor as an example. A boiling water type light water reactor is a pressure vessel with a fuel body (fuel rods) loaded inside and filled with coolant water (nuclear reactor feed water 51) to a specific water level. The nuclear reactor 2 is loaded with control rods to control the nuclear fission of the fuel body, in which the position of the control rods determines the rate of nuclear fission. Withdrawal of the control rods promotes the nuclear fission reaction, generating heat that boils the coolant water in the nuclear reactor to produce the steam from an upper portion of the nuclear reactor.

Although not shown in the figure, a thermal output of the nuclear reactor 2 can also be controlled by withdrawing some of the nuclear reactor coolant water in the nuclear reactor 2 and recirculating it back to a lower portion of the nuclear reactor.

The steam generated in the nuclear reactor 2 drives the high-pressure turbine 3 after passing through the main steam control valve 8. Exhaust steam from the high-pressure turbine 3 is reheated in the moisture separation heater 4 with a portion of the steam from the nuclear reactor 2 to drive the low-pressure turbine 5.

A portion of the steam from the nuclear reactor 2 is used as a reheat source for the steam in the moisture separation heater 4. This steam is branched off from the upstream of the main steam control valve 8 and supplied to the moisture separation heater 4 after its flow rate is adjusted by the adjustment valve 9. The steam used for heating condenses and becomes ready for draining to be part of the nuclear reactor feed water 51.

The driving force of the high-pressure turbine 3 and the low-pressure turbine 5 rotates the power generator 7 via the drive shaft 6 to obtain electric power. Turbine exhaust 9, after driving the low-pressure turbine 5, is condensed in a condenser, which is not shown in the figure, and is reinjected into the nuclear reactor 2 as the nuclear reactor feed water 51.

The nuclear power plant 1 described above is controlled by the plant control device 100. The plant control device 100 according to the present embodiment obtains a power generation output command 10 as a command from a central load dispatching instruction office and forms a control system with a nuclear reactor pressure measurement value 17 and a power generator output measurement value 13 as feedback signals.

The plant control device 100 includes an integrated plant control section 101 as an upper-level control system that controls an entire nuclear power plant 1 to be balanced based on the power generation output command 10, and a main steam control valve control section 102 and a nuclear reactor control section 103 as lower-level control systems that control each portion of the nuclear power plant 1 in accordance with the output of the integrated plant control section 101. In addition, it further includes a pressure control section 104 as an upper-level control system of the nuclear reactor control section 103.

Essentially, the configuration of this control system is such that the integrated plant control section 101 defines a nuclear reactor thermal output command 12, which corresponds to an input of the nuclear power plant 1, and a turbine power generator output command 11, which corresponds to an output of the nuclear power plant 1, the nuclear reactor control section 103 defines a nuclear reactor operation command 15 and a nuclear reactor pressure setting value 16 in accordance with the nuclear reactor thermal output command 12, and the main steam control valve control section 102 defines a main steam control valve opening degree command 14 in response to the turbine power generator output command 11. In addition, the pressure control section 104 defines a pressure adjustment valve opening degree command 18 in accordance with the nuclear reactor pressure setting value 16.

The operation of each control section is described in detail below. First, an example of a schematic configuration of the integrated plant control section 101 is shown in FIG. 2. The integrated plant control section 101 outputs the turbine power generator output command 11 and the nuclear reactor thermal output command 12 based on the power generation output command 10.

In the integrated plant control section 101, a power generation output control means 110 first determines a turbine power generator output command before pressure limitation 19 so that the command allows the turbine power generator 7 to follow the power generation output command 10.

Next, a nuclear reactor pressure deviation 21 is input from the pressure adjustment valve control section 104 to a control valve opening degree correction means 111, and if the nuclear reactor pressure deviation is outside a specific range, the turbine power generator output command before the pressure limitation 19 with a limited rate of change is output as the turbine power generator output command 11. The nuclear reactor pressure deviation 21 is the output of the pressure control section 104, the details of which are described below.

A thermal output control means 112 determines the nuclear reactor thermal output command 12 from the power generation output command 10 so that the command allows the nuclear reactor thermal output to follow the power generation output command 10.

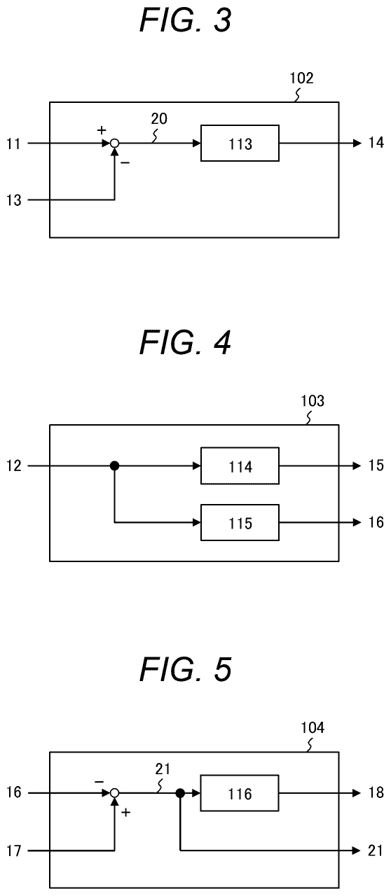

An example of a schematic configuration of the main steam control valve control section 102 is shown in FIG. 3.

The main steam control valve control section 102 receives the turbine power generator output command 11 and the power generator output measurement value 13 and outputs the main steam control valve opening degree command 14.

The main steam control valve control section 102 shown in FIG. 3 determines a power generation output deviation 20 from the difference between the turbine power generator output command 11 and the power generator output measurement value 13. A control valve control means 113 calculates and outputs the main steam control valve opening degree command 14 so that this power generation output deviation 20 is equal to zero, in other words, the power generator output command and the output measurement value are equal.

An example of a schematic configuration of the nuclear reactor control section 103 is shown in FIG. 4. The nuclear reactor control section 103 receives the nuclear reactor thermal output command 12 and outputs the nuclear reactor operation command 15 and the nuclear reactor pressure setting value 16.

The nuclear reactor control section 103 determines the nuclear reactor operation command 15 so that the nuclear reactor thermal output follows the nuclear reactor thermal output command 12 in a control rod control means 114. It also determines the nuclear reactor pressure setting value 16 from the nuclear reactor thermal output command 12 in a pressure target value setting means 115.

An example of a schematic configuration of the pressure control section 104 is shown in FIG. 5. The pressure control section 104 receives the nuclear reactor pressure setting value 16 and the nuclear reactor pressure measurement value 17 and outputs the pressure adjustment valve opening degree command 18.

The pressure control section 104 calculates and outputs the pressure adjustment valve opening degree command 18 so that the nuclear reactor pressure deviation 21 is equal to zero in a pressure adjustment valve control means 116. In the present example, the pressure adjustment valve opening degree command 18 is used to control the adjustment valve 9 that adjusts a steam flow rate to the moisture separation heater 4. Note that the nuclear reactor pressure deviation 21 is used to limit the turbine power generator output command in the integrated plant control section 101.

As described above, the starting point of operation when controlling the power generation output in a conventional nuclear power plant is the nuclear reactor, and the main steam control valve is increased in accordance with an increase in the nuclear reactor thermal output. In contrast, in the plant control device according to the present invention, both the main steam control valve 8 and the nuclear reactor 2 are the starting point of operation in response to the power generation output command 10 from the central load dispatching instruction office and are controlled at the same time. The difference between a steam consumption volume in the turbine and a steam generation volume in the nuclear reactor 2 resulting from the control is adjusted by the pressure adjustment valve 9. The steam flow rate passing through the pressure adjustment valve 9 is used to reheat the steam in the moisture separation heater 4, and this steam flow rate increases or decreases during load control.

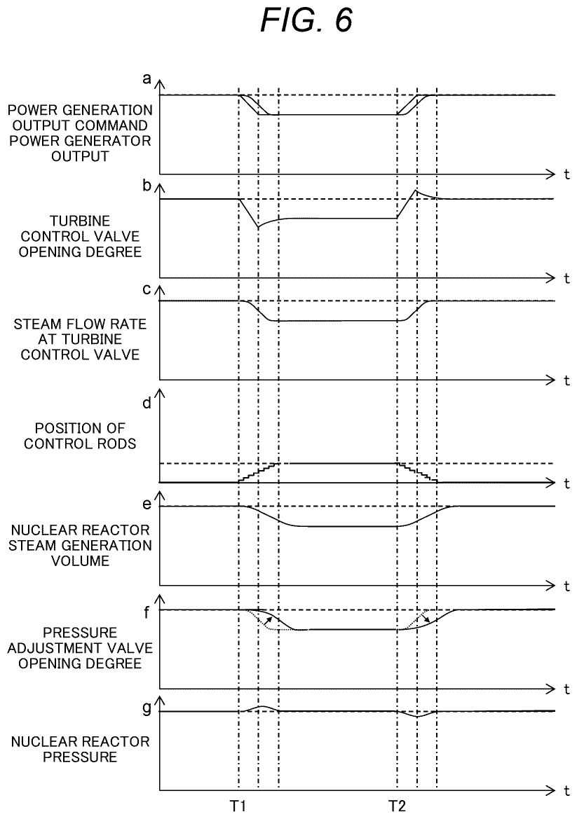

Next, operation characteristics of the nuclear power plant when the power generation output is controlled are described with reference to FIG. 6. This figure illustrates the operation characteristics of each part of the plant in a time series graph when the nuclear reactor 2, the turbine power generator and the adjustment valve are controlled in response to an increase or a decrease in the power generation output command from the central load dispatching instruction office. The horizontal axis of the figure represents time in each graph, in which output reduction is performed at time T1 and output increase is performed at time T2. The vertical axes a through g represent the operation characteristics of each part in the plant and are normalized with a rated operating condition defined as 100% and shown in the figure.

In FIG. 6, axis a represents the power generation output, illustrating each of the power generation output command and the power generator output. Note that in a of FIG. 6, the power generation output command changes ahead of time, and the power generator output follows the change in the same direction after that.

Note that when the power generation output command is reduced at time T1, the steam flow rate passing through the main steam control valve on axis c decreases by reducing the main steam control valve opening degree shown on axis b, resulting in a reduction in the power generator output on axis a. At the same time, the nuclear reactor suppresses the reaction in a reactor core by increasing the position of the control rods (in other words, inserting them into the reactor core) as shown on axis d to reduce the thermal output. As a result, a nuclear reactor steam generation volume shown on axis e decreases with a time delay.

In the present invention, when the power generation output command is reduced, the opening degree of the adjustment valve shown on axis f is maintained at a higher level than in conventional operation (shown by the dotted line). As a result, the nuclear reactor pressure shown on axis g temporarily increases but is kept to a level that does not affect the reaction in the reactor core. The reason why the main steam control valve opening degree shown on axis b temporarily stays low (excessively reduced) compared to the power generator output command is to suppress the increase in the steam flow rate at the main steam control valve due to the temporary increase in the nuclear reactor pressure shown on axis g, in other words, the increase in the power generator output.

The operation characteristics of the plant when the power generation output increases at time T2 are described also with reference to FIG. 6.

When the power generation output command is increased at time T2, the steam flow rate passing through the main steam control valve on axis c increases by increasing the main steam control valve opening degree shown on axis b, resulting in an increase in the power generator output on axis a. At the same time, the nuclear reactor promotes the reaction in the reactor core by decreasing the position of the control rods (in other words, withdrawing them from the reactor core) as shown on axis d to increase the thermal output. As a result, the nuclear reactor steam generation volume shown on axis e increases with a time delay.

In the present invention, when the power generation output command is increased, the opening degree of the adjustment valve shown on axis f is maintained at a lower level than in the conventional operation (shown by the dotted line). As a result, the nuclear reactor pressure shown on axis g temporarily decreases but is kept to a level that does not affect the reaction in the reactor core. The reason why the main steam control valve opening degree shown on axis b temporarily stays high (excessively increased) compared to the power generator output command is to compensate the decrease in the steam flow rate at the main steam control valve due to the temporary decrease in the nuclear reactor pressure shown on axis g, in other words, the decrease in the power generator output.

Note that an adjustment range of the power generation output (in other words, load-following performance) according to the present invention depends on a variation range of a steam supply volume that can be supplied to the moisture separation heater, and thus is applied to the fine adjustment of the power supply-demand balance, not to the rapid and significant load changes seen in general coal-fired or gas-fired power plants. Although a reheating amount of the steam in the moisture separation heater is changed according to the present invention, the fluctuation of a steam temperature at an inlet to the low-pressure turbine is very small when the output is adjusted within the range of the application described above, thus having a small effect on the power generation output.

The nuclear power plant and the plant control device according to the present invention can be realized only by modifying the control device without requiring significant changes to equipment configurations of the nuclear power plant that is already in practical use. Therefore, the nuclear power plants that are already in operation can be utilized for output adjustment.

The nuclear power plant and the plant control device according to the present invention can control the pressure of the nuclear reactor with the steam flow rate supplied to the moisture separation heater, thereby enabling stable control of the nuclear reactor pressure not only for output adjustment but also for pressure fluctuation factors attributable to both the nuclear reactor and the turbine.

Therefore, the nuclear reactor can be stably operated not only when the power generator output is changed but also when operated at a constant output.

According to the plant control device of the nuclear power plant according to the present invention described above, the integrated plant control means determines the output command of the turbine power generator and the thermal output command of the nuclear reactor in response to the power generation output command from the load dispatching offices. The turbine power generator and the nuclear reactor are controlled in accordance with the turbine power generator output command and the nuclear reactor thermal output command, respectively. The steam generation volume from the nuclear reactor and the steam consumption volume in the turbine are changed by changes in the nuclear reactor thermal output and the turbine power generator output command, respectively, resulting in inconsistent volumes of steam between the nuclear reactor and the turbine power generator. This inconsistency appears as a change in pressure at the upper portion of the nuclear reactor. Therefore, adjusting the opening degree of the pressure adjustment valve of the nuclear reactor so that the nuclear reactor pressure measurement value is equal to the pressure target value of the nuclear reactor suppresses a sudden pressure change of the nuclear reactor to ensure the stable operation of the nuclear reactor.

The plant control device of the nuclear power plant according to the present invention also suppresses a sudden pressure change of the nuclear reactor by increasing or decreasing the opening degree of the pressure adjustment valve of the nuclear reactor. Therefore, unexpected fluctuations in the volume of steam flowing into the turbine can be suppressed, allowing high-quality power that follows the power generation output command to be obtained.

Industrial Applicability The present invention can be utilized for a nuclear power plant, especially a boiling water type nuclear power plant that supplies main steam generated in the nuclear reactor to the turbine to generate electricity and a plant output control device.

Reference Signs List 1: nuclear power plant 2: nuclear reactor 3: high-pressure turbine 4: moisture separation heater 5: low-pressure turbine 6: drive shaft 7: power generator 8: main steam control valve 9: adjustment valve 10: power generation output command 11: turbine power generator output command 12: nuclear reactor thermal output command 13: power generator output measurement value 14: main steam control valve opening degree command 15: nuclear reactor operation command 16: nuclear reactor pressure setting value 17: nuclear reactor pressure measurement value 18: pressure adjustment valve opening degree command 19: turbine power generator output command before pressure limitation 20: power generation output deviation 21: nuclear reactor pressure deviation 50: turbine exhaust 51: nuclear reactor feed water 100: plant control device 101: integrated plant control section 102: main steam control valve control section 103: nuclear reactor control section 104: pressure control section 105: power generation output control means 111: control valve opening degree correction means 112: thermal output control means 113: control valve control means 114: control rod control means 115: pressure target value setting means 116: pressure adjustment valve control means

1. A nuclear power plant in which steam generated in a nuclear reactor is supplied to a high-pressure turbine through a main steam control valve, and a portion of the steam generated in the nuclear reactor is supplied to a moisture separation heater through an adjustment valve to heat exhaust steam from the high-pressure turbine, wherein a nuclear reactor pressure is controlled by adjusting the volume of steam to the moisture separation heater.

2. The nuclear power plant according to claim 1, wherein an opening degree of the adjustment valve is controlled in accordance with a difference between a nuclear reactor pressure setting value and a nuclear reactor pressure measurement value.

3. A control device for a nuclear power plant in which steam generated in a nuclear reactor is supplied to a high-pressure turbine through a main steam control valve, and a portion of the steam generated in the nuclear reactor is supplied to a moisture separation heater through an adjustment valve to heat exhaust steam from the high-pressure turbine,
the control device comprising: an integrated plant control section that determines a turbine power generator output command and a nuclear reactor thermal output command from a power generation output command provided; a main steam control valve control section that determines an opening degree command for the main steam control valve in response to the turbine power generator output command; a nuclear reactor control section that determines a nuclear reactor operation command and a nuclear reactor pressure setting value in response to the nuclear reactor thermal output command; and a pressure control section that controls an opening degree of the adjustment valve in accordance with a difference between the nuclear reactor pressure setting value and the nuclear reactor pressure measurement value.

4. The control device for a nuclear power plant according to claim 3,
wherein a rate of change of the opening degree of a turbine governor that controls a turbine power generator output is limited when the difference between the nuclear reactor pressure setting value and the nuclear reactor pressure measurement value exceeds a predetermined value.

5. A control method for a nuclear power plant in which steam generated in a nuclear reactor is supplied to a high-pressure turbine through a main steam control valve, and a portion of the steam generated in the nuclear reactor is supplied to a moisture separation heater through an adjustment valve to heat exhaust steam from the high-pressure turbine,
the control method comprising: determining a turbine power generator output command and a nuclear reactor thermal output command from a power generation output command provided; determining an opening degree command for the main steam control valve in response to the turbine power generator output command; determining a nuclear reactor operation command and a nuclear reactor pressure setting value in response to the nuclear reactor thermal output command; and controlling an opening degree of the adjustment valve in accordance with a difference between the nuclear reactor pressure setting value and the nuclear reactor pressure measurement value.

6. The control method for a nuclear power plant according to claim 5,
wherein a rate of change of the opening degree of a turbine governor that controls a turbine power generator output is limited when the difference between the nuclear reactor pressure setting value and the nuclear reactor pressure measurement value exceeds a predetermined value.
